(19) United States
(12) Patent Application Publication
(10) Pub. No.: US 2020/0033679 A1
(43) Pub. Date: Jan. 30, 2020

(54) LCD PANEL AND MANUFACTURING METHOD THEREOF

(71) Applicant: Wuhan China Star Optoelectronics Technology Co., Ltd., Wuhan (CN)

(72) Inventor: Bingkun Yin, Wuhan (CN)

(73) Assignee: Wuhan China Star Optoelectronics Technology Co., Ltd., Wuhan (CN)

(21) Appl. No.: 16/313,047

(22) PCT Filed: Sep. 22, 2018
(86) PCT No.: PCT/CN2018/107155

§ 371 Date: Dec. 23, 2018

(30) Foreign Application Priority Data
Jul. 24, 2018 (CN) 201810822291.0

(51) Int. Cl. G02F 1/1337; G02F 1/1339; G02F 1/1362

(52) U.S. Cl. CPC G02F 1/133788; G02F 2001/136222; G02F 1/136209; G02F 1/1339

(57) ABSTRACT

The present invention teaches a LCD panel and a LCD panel manufacturing method. The LCD panel of the present invention has a sealant first formed between first and second substrate stacks, and a self-aligned liquid crystal material is filled between the substrate stacks to obtain a liquid crystal cell. The liquid crystal cell is then baked and exposed to UV light to align the self-aligned liquid crystal material and form a self-aligned liquid crystal layer. The range and location precision of a self-alignment layer within the self-aligned liquid crystal layer is controlled through the coated area of the sealant to achieve precise location and uniform film thickness in the periphery of the self-alignment layer. The present invention is as such more appropriate in achieving narrow bezel design.

### FIELD OF THE INVENTION

The present invention is generally related to the field of display technology, and more particularly to a LCD panel and a related manufacturing method.

### BACKGROUND OF THE INVENTION

In the field of display technologies, flat panel display devices such as liquid crystal display (LCD) devices, due to their thin thickness, high quality, power saving, and low radiation, have gradually replaced cathode ray tube (CRT) display devices.

Existing LCD devices are usually back-lighted display devices, and include a LCD panel and a backlight module. The LCD panel usually include a color filter (CF) substrate, a thin film transistor (TFT) array substrate, and a liquid crystal layer and a sealant disposed between the two substrates. The principle behind a LCD panel is to alter the alignment of the liquid crystal molecules in the liquid crystal layer by the electrical field formed between the substrates. As such, light from the backlight module is refracted to produce pictures.

An alignment film is required to align the liquid crystal molecules along a specific direction and the alignment film is disposed to cover the active area (AA) of the LCD panel. Conventionally, an alignment film is made by transfer printing or coating a polyimide (PI) solution with dissolved polymeric compound on a substrate, and then baking the PI solution.

Due to the universal popularity of mobile phones, people have increasing demand for the display quality of mobile phones. Ultra slim bezel is one such trend and it poses new challenge to the product design and manufacturing. For the alignment film, it has to be coated with high precision and the area outside the AA has be minimized so as not to cover the chip bonding area outside the AA. However, due to the limitation of the existing art, transfer printing or spray coating is difficult to achieve the thickness uniformity and location precision required by the ultra slim bezel. Bezel dimension cannot be further reduced so as to prevent the alignment film from covering the chip bonding area.

### SUMMARY OF THE INVENTION

An objective of the present invention is to teach a LCD panel appropriate for narrow bezel design.

Another objective of the present invention is to teach a LCD panel manufacturing method capable of achieving narrow bezel design.

To achieve the objectives, the present invention first teaches a LCD panel, comprising oppositely disposed first substrate stack and second substrate stack, a self-aligned liquid crystal layer between the first and second substrate stacks, and a sealant between the first and second substrate stacks surrounding the self-aligned liquid crystal layer, wherein

the self-aligned liquid crystal layer comprises two self-alignment layers and a liquid crystal molecular layer sandwiched between the two self-alignment layers.

The first substrate stack comprises a first substrate, a plurality of color resist blocks arranged in an array on a side of the first substrate, and a black matrix on the side of the first substrate with the color resist blocks between neighboring color resist blocks and outside the array of color resist blocks.

The first substrate comprises an active area and a peripheral area surrounding the active area; the color resist blocks are within the active area; the black matrix covers the peripheral area.

The second substrate stack comprises a second substrate, and a metallic layout on a side of the second substrate adjacent to the self-aligned liquid crystal layer; the metallic layout extends from the active area to the peripheral area; and

the sealant is within the peripheral area, and covers a portion of the metallic layout extended into the peripheral area.

The LCD panel further comprises a protection layer covering the color resist blocks and the black matrix.

The present invention also teaches a manufacturing method, which includes the following steps:

S1: providing a first substrate stack and a second substrate stack;

S2: forming a sealant between the first and second substrate stacks, and filling a self-aligned liquid crystal material between the first and second stacks and the sealant to obtain a liquid crystal cell;

S3: baking the liquid crystal cell with a temperature higher than a clearing point temperature of the self-aligned liquid crystal material; and

S4: forming a self-aligned liquid crystal layer between the first and second stacks and the sealant by maintaining a temperature of the liquid crystal cell above the clearing point temperature of the self-aligned liquid crystal material while exposing the liquid crystal cell to UV light;

wherein the self-aligned liquid crystal layer comprises two self-alignment layers and a liquid crystal molecular layer sandwiched between the two self-alignment layers.

In step S2, the self-aligned liquid crystal material is filled between the first and second stacks and the sealant using injection or drop filling.

The LCD panel manufacturing method further comprises a step S5: cooling the liquid crystal cell down to room temperature while continuously exposing the liquid crystal cell to UV light.

The first substrate stack comprises a first substrate, a plurality of color resist blocks arranged in an array on a side of the first substrate adjacent to the self-aligned liquid crystal layer, a black matrix on a side of the first substrate adjacent to the self-aligned liquid crystal layer between neighboring color resist blocks and outside the array of color resist blocks, and a protection layer covering the color resist blocks and the black matrix; the first substrate comprises an active area and a peripheral area surrounding the active area; the color resist blocks are within the active area; and the black matrix covers the peripheral area;

the second substrate stack comprises a second substrate, and a metallic layout on a side of the second substrate adjacent to the self-aligned liquid crystal layer;

in step S2, the sealant is formed between the side of the first substrate stack having the protection layer and the side of the second substrate stack having the metallic layout; after the step S2, the metallic layout is extended outside the active area into the peripheral area; and

the sealant is within the peripheral area and covers an end section of the metallic layout that is within the peripheral area.

In step S4, the liquid crystal cell is exposed to a polarized UV light.

The advantages of the present invention are as follows. The LCD panel of the present invention has oppositely disposed first and second substrate stacks, the self-aligned liquid crystal layer sandwiched between the first and second substrate stacks, and the sealant between the first and second substrate stacks surrounding the self-aligned liquid crystal layer. The self-aligned liquid crystal layer includes the liquid crystal molecular layers sandwiched between the two self-alignment layers. When manufacturing the LCD panel, the sealant may be formed between the first and second substrate stacks first. Then self-aligned liquid crystal material is filled between the substrate stacks and the sealant to obtain the liquid crystal cell. The liquid crystal cell is then baked and exposed to UV light to align the self-aligned liquid crystal material and form the self-aligned liquid crystal layer. The range and location precision of the self-alignment layer within the self-aligned liquid crystal layer is controlled through the coated area of the sealant to achieve precise location and uniform film thickness in the periphery of the self-alignment layer. The present invention is as such more appropriate in achieving narrow bezel design.

### BRIEF DESCRIPTION OF THE DRAWINGS

In order to more clearly illustrate the embodiments of the present invention or prior art, the following figures will be described in the embodiments are briefly introduced. It is obvious that the drawings are merely some embodiments of the present invention, those of ordinary skill in this field can obtain other figures according to these figures without paying the premise.

FIG. 1 is a structural schematic diagram showing a LCD panel according to an embodiment of the present invention.

FIG. 2 is a flow diagram showing a LCD panel manufacturing method according to an embodiment of the present invention.

FIG. 3 is a schematic diagram showing a step S1 of the LCD panel manufacturing method of FIG. 2.

FIG. 4 is a schematic diagram showing a step S2 of the LCD panel manufacturing method of FIG. 2.

### DETAILED DESCRIPTION OF PREFERRED EMBODIMENTS

The following descriptions for the respective embodiments are specific embodiments capable of being implemented for illustrations of the present invention with referring to appended figures.

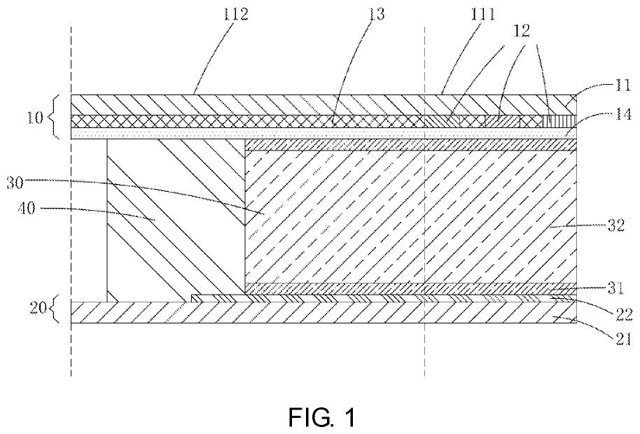

As shown in FIG. 1, a LCD panel according to an embodiment of the present invention includes oppositely disposed first substrate stack 10 and second substrate stack 20, a self-aligned liquid crystal layer 30 between the first and second substrate stacks 10 and 20, and a sealant 40 between the first and second substrate stacks 10 and 20, surrounding the self-aligned liquid crystal layer 30.

The self-aligned liquid crystal layer 30 includes two self-alignment layers 31 and a liquid crystal molecular layer 32 sandwiched between the two self-alignment layers 31.

Specifically, as shown in FIG. 1, the first substrate stack 10 includes a first substrate 11, multiple color resist blocks 12 arranged in an array on a side of the first substrate 11 adjacent to the self-aligned liquid crystal layer 30, and a black matrix 13 between neighboring color resist blocks 12 and outside the array of color resist blocks 12.

Specifically, as shown in FIG. 1, the first substrate 11 includes an active area 111 and a peripheral area 112 surrounding the active area 111. The color resist blocks 12 are within the active area 111. The black matrix 13 covers the peripheral area 112. The color resist blocks 12 includes sequentially arranged red, green, and block color resist blocks. There may be color resist blocks 12 of other colors such as yellow color resist blocks.

Specifically, as shown in FIG. 1, the second substrate stack 20 includes a second substrate 21, and a metallic layout 22 on a side of the second substrate 21 adjacent to the self-aligned liquid crystal layer 30. The metallic layout 22 extends from the active area 111 to the peripheral area 112.

Specifically, the sealant 40 is within the peripheral area 112, and covers a portion of the metallic layout 22 extended into the peripheral area 112.

Specifically, the first substrate stack 10 further includes a protection layer 14 covering the color resist blocks 12 and the black matrix 13. A portion of the sealant 40 adjacent to the first substrate stack 10 is connected to the protection layer 14.

It should be noted that the LCD panel of the present invention has the self-aligned liquid crystal layer 30 sandwiched between the first and second substrate stacks 10 and 20, the self-aligned liquid crystal layer 30 includes self-alignment and liquid crystal molecular layers 31 and 32, and sandwiched between the two self-alignment layers 31, and the sealant 40 is configured between the first and second substrate stacks 10 and 20, surrounding the self-aligned liquid crystal layer 30. When manufacturing the LCD panel, the sealant 40 may be formed between the first and second substrate stacks 10 and 20 first. Then self-aligned liquid crystal material is filled between the substrate stacks 10 and 20, and the sealant 40 to obtain the liquid crystal cell. The liquid crystal cell is then baked and exposed to ultra-violet (UV) light to align the self-aligned liquid crystal material and form the self-aligned liquid crystal layer 30. The range and location precision of the self-alignment layer 31 within the self-aligned liquid crystal layer 30 is controlled through the coated area of the sealant 40 to achieve precise location and uniform film thickness in the periphery of the self-alignment layer 31. In contrast, the prior art's using transfer printing or spray coating leads to less uniform film thickness and inferior location precision, thereby requiring wider bezel to prevent chip bonding terminals from being covered by the alignment film. The present invention is as such more appropriate in achieving narrow bezel design.

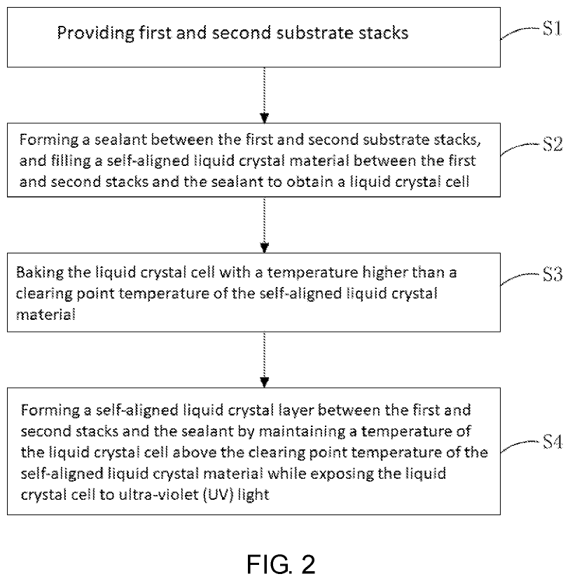

As shown in FIG. 2, a LCD panel manufacturing method according to an embodiment of the present invention includes the following steps.

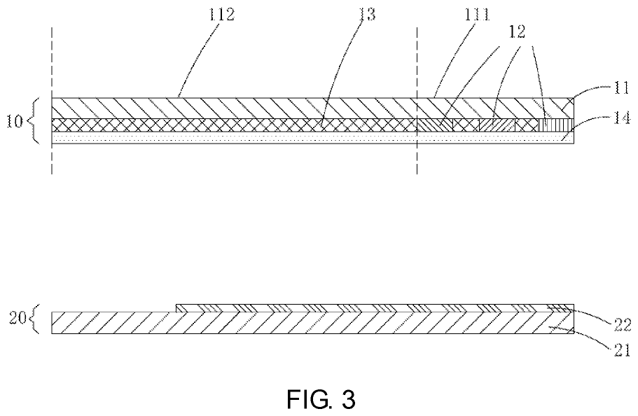

Step S1: as shown in FIG. 3, providing a first substrate stack 10 and a second substrate stack 20.

Specifically, the first substrate stack 10 includes a first substrate 11, multiple color resist blocks 12 arranged in an array on a side of the first substrate 11, a black matrix 13 on the side of the first substrate 11 with the color resist blocks 12 between neighboring color resist blocks 12 and outside the array of color resist blocks 12, and a protection layer 14 covering the color resist blocks 12 and the black matrix 13. The first substrate 11 includes an active area 111 and a peripheral area 112 surrounding the active area 111. The color resist blocks 12 are within the active area 111. The black matrix 13 covers the peripheral area 112. The second substrate stack 20 includes a second substrate 21, and a metallic layout 22 on a side of the second substrate 21.

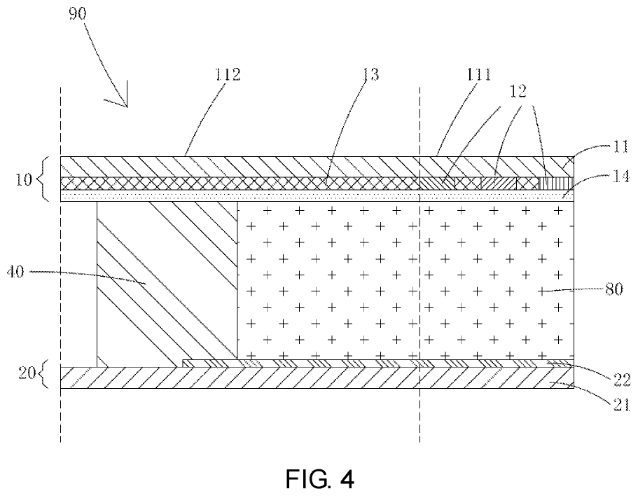

Step S2: as shown in FIG. 4, forming a sealant 40 between the first and second substrate stacks 10 and 20, and filling self-aligned liquid crystal material 80 between the first and second stacks 10 and 20 and the sealant 40 to obtain a liquid crystal cell 90.

Specifically, in step S2 as shown in FIG. 4, the sealant 40 is formed between the side of the first substrate stack 10 having the protection layer 14 and the side of the second substrate stack 20 having the metallic layout 22. After the step S2, the metallic layout 22 is extended outside the active area 111 into the peripheral area 112. The sealant 40 covers an end section of the metallic layout 22 that is within the peripheral area 112.

Specifically, in step S2, the self-aligned liquid crystal material 80 is filled between the first and second stacks 10 and 20 and the sealant 40 using injection or drop filling.

Step S3: baking the liquid crystal cell 90 at a temperature higher than a clearing point temperature of the self-aligned liquid crystal material 80.

Step S4: forming a self-aligned liquid crystal layer 30 between the first and second stacks 10 and 20 and the sealant 40 by maintaining a temperature of the liquid crystal cell 90 above the clearing point temperature of the self-aligned liquid crystal material 80 while the liquid crystal cell 90 is exposed to UV light. The self-aligned liquid crystal layer 30 comprises two self-alignment layers 31 and a liquid crystal molecular layer 32 sandwiched between the two self-alignment layers 31.

Specifically, in step S4, the liquid crystal cell is exposed to a polarized UV light.

Step S5: cooling the liquid crystal cell 90 down to room temperature while continuously exposing the liquid crystal cell 90 to UV light.

It should be noted that the LCD panel of the present invention has the sealant 40 configured between the first and second substrate stacks 10 and 20, and then self-aligned liquid crystal material 80 is filled between the substrate stacks 10 and 20, and the sealant 40 to obtain the liquid crystal cell 90. The liquid crystal cell 90 is then baked and exposed to UV light to align the self-aligned liquid crystal material and form the self-aligned liquid crystal layer 30. The range and location precision of the self-alignment layer 31 within the self-aligned liquid crystal layer 30 is controlled through the coated area of the sealant 40 to achieve precise location and uniform film thickness in the periphery of the self-alignment layer 31. In contrast, the prior art's using transfer printing or spray coating leads to less uniform film thickness and inferior location precision, thereby requiring wider bezel to prevent chip bonding terminals from being covered by the alignment film. The present invention is as such more appropriate in achieving narrow bezel design.

As described above, the LCD panel of the present invention has oppositely disposed first and second substrate stacks, the self-aligned liquid crystal layer sandwiched between the first and second substrate stacks, and the sealant between the first and second substrate stacks surrounding the self-aligned liquid crystal layer. The self-aligned liquid crystal layer includes the liquid crystal molecular layers sandwiched between the two self-alignment layers. When manufacturing the LCD panel, the sealant may be formed between the first and second substrate stacks first. Then self-aligned liquid crystal material is filled between the substrate stacks and the sealant to obtain the liquid crystal cell. The liquid crystal cell is then baked and exposed to UV light to align the self-aligned liquid crystal material and form the self-aligned liquid crystal layer. The range and location precision of the self-alignment layer within the self-aligned liquid crystal layer is controlled through the coated area of the sealant to achieve precise location and uniform film thickness in the periphery of the self-alignment layer. The present invention is as such more appropriate in achieving narrow bezel design.

Above are embodiments of the present invention, which does not limit the scope of the present invention. Any equivalent amendments within the spirit and principles of the embodiment described above should be covered by the protected scope of the invention.

What is claimed is:

1. A liquid crystal display (LCD) panel, comprising oppositely disposed first substrate stack and second substrate stack, a self-aligned liquid crystal layer between the first and second substrate stacks, and a sealant between the first and second substrate stacks surrounding the self-aligned liquid crystal layer, wherein
the self-aligned liquid crystal layer comprises two self-alignment layers and a liquid crystal molecular layer sandwiched between the two self-alignment layers.

2. The LCD panel according to claim 1, wherein the first substrate stack comprises a first substrate, a plurality of color resist blocks arranged in an array on a side of the first substrate adjacent to the self-aligned liquid crystal layer, and a black matrix on a side of the first substrate adjacent to the self-aligned liquid crystal layer between neighboring color resist blocks and outside the array of color resist blocks.

3. The LCD panel according to claim 2, wherein the first substrate comprises an active area and a peripheral area surrounding the active area; the color resist blocks are within the active area; and the black matrix covers the peripheral area.

4. The LCD panel according to claim 3, wherein the second substrate stack comprises a second substrate, and a metallic layout on a side of the second substrate adjacent to the self-aligned liquid crystal layer; the metallic layout extends from the active area to the peripheral area; and
the sealant is within the peripheral area, and covers a portion of the metallic layout extended into the peripheral area.

5. The LCD panel according to claim 2, wherein the first substrate stack further comprises a protection layer covering the color resist blocks and the black matrix.

6. A LCD panel manufacturing method, comprising
S1: providing a first substrate stack and a second substrate stack;
S2: forming a sealant between the first and second substrate stacks, and filling a self-aligned liquid crystal material between the first and second stacks and the sealant to obtain a liquid crystal cell;
S3: baking the liquid crystal cell with a temperature higher than a clearing point temperature of the self-aligned liquid crystal material; and
S4: forming a self-aligned liquid crystal layer between the first and second stacks and the sealant by maintaining a temperature of the liquid crystal cell above the clearing point temperature of the self-aligned liquid crystal material while exposing the liquid crystal cell to ultra-violet (UV) light;
wherein the self-aligned liquid crystal layer comprises two self-alignment layers and a liquid crystal molecular layer sandwiched between the two self-alignment layers.

7. The LCD panel manufacturing method according to claim 6, wherein, in step S2, the self-aligned liquid crystal material is filled in the space using injection or drop filling.

8. The LCD panel manufacturing method according to claim 6, further comprising a step S5: cooling the liquid crystal cell down to room temperature while continuously exposing the liquid crystal cell to UV light.

9. The LCD panel manufacturing method according to claim 6, wherein the first substrate stack comprises a first substrate, a plurality of color resist blocks arranged in an array on a side of the first substrate adjacent to the self-aligned liquid crystal layer, a black matrix on a side of the first substrate adjacent to the self-aligned liquid crystal layer between neighboring color resist blocks and outside the array of color resist blocks, and a protection layer covering the color resist blocks and the black matrix; the first substrate comprises an active area and a peripheral area surrounding the active area; the color resist blocks are within the active area; and the black matrix covers the peripheral area;
the second substrate stack comprises a second substrate, and a metallic layout on a side of the second substrate adjacent to the self-aligned liquid crystal layer;
in step S2, the sealant is formed between the side of the first substrate stack having the protection layer and the side of the second substrate stack having the metallic layout; after the step S2, the metallic layout is extended outside the active area into the peripheral area; and the sealant covers an end section of the metallic layout that is within the peripheral area.

10. The LCD panel manufacturing method according to claim 6, wherein, in step S4, the liquid crystal cell is exposed to a polarized UV light.
